(19) United States
(12) Patent Application Publication
(10) Pub. No.: US 2002/0059108 A1
(43) Pub. Date: May 16, 2002

(54) Electronic commerce goods data search method and system with the addition of distributor strategy

(76) Inventors: Masao Okura, Sagamihara (JP); Masahiro Ogura, Sakura (JP); Akira Ishibashi, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/888,192

(22) Filed: Jun. 21, 2001

(30) Foreign Application Priority Data
Nov. 10, 2000 (JP) P2000-349327

(51) Int. Cl. G06F 17/60

(52) U.S. Cl. 705/26

(57) ABSTRACT

The present invention relates generally to electronic commerce and more particularly to consumer goods offered by a distributor over a communications network, for example, the Internet. One embodiment of the present invention provides a method for determining goods offered to a consumer by a distributor based on the distributor's business strategy. The consumer specifies his/her needs and the distributor first finds goods that meets the consumers needs. The distributor then prioritizes these goods based on the distributor's own business needs and offers the customer only those goods that meet both the customer's and the distributor's needs. Thus a distributor filtered viewpoint of the goods is displayed to the customer.

### CROSS REFERENCES TO RELATED APPLICATIONS

This application is related to and claims priority from Japanese Patent Application No. 2000-349327, filed on Nov. 10, 2000.

### BACKGROUND OF THE INVENTION

The present invention relates generally to electronic commerce and more particularly to consumer goods offered by a distributor over a communications network, for example, the Internet. Another example would be On-line shopping over the web.

In recent years, electronic commerce using networks has become prevalent. A typical procedure used in electronic commerce is as follows: a consumer who enters a cyber mall on a network first selects a commodity as he/she wants to buy based on his/her conditions of purchase and sends the order data for the commodity to the distributor. If the customer seeks a complex product such as a personal computer into which many components are assembled, it is time-consuming to select the component specifications matching the consumer's intended purpose out of a great number of components. One means for solving such a problem, an “Electronic Commerce System” was disclosed in Japanese Patent Laid-Open Publication No. Hei 11-15887. In this system the consumer is only required to specify his or her requirements in a broad sense and the system translates these requirements into definite requirements and specifications, based on which the system offers commodity candidates of order to the consumer.

However, in above described “Electronic Commerce System,” the intention of the distributor is not reflected in the means of translating the consumer-specified general requirements into definite specifications and in the determining of commodity candidates of order. If there are a plurality of commodity candidates and specifications meeting the consumer-specified general requirements, it is difficult for the system to prioritize the specifications and commodities that the distributor intends to sell particularly in view of the distributor's strategy such as “early selling of excessive stock” or “channel strategy articles.”. Thus the problem is that the distributor cannot implement its sales strategy in the above system.

Thus there is a need for techniques that meet both users' and distributors' requirements. In particular there is a need for the distributor to filter the products offered the users based on the distributor's strategy.

### SUMMARY OF THE INVENTION

The present invention provides a method and system for determining goods offered to a consumer by a distributor based on the distributor's business strategy. The consumer specifies his/her needs and the distributor first finds goods that meets the consumers needs. The distributor then prioritizes these goods based on the distributor's own business needs and offers the customer only those goods that meet both the customer's and the distributor's needs. Thus a distributor filtered viewpoint of the goods is displayed to the customer.

One embodiment of the present invention offers an electronic commerce goods data search method comprising: a step of allowing the consumer to specify broad conditions for seeking some commodity candidates to order and buy; a step of searching for commodities of definite specifications meeting the conditions specified by the consumer, while prioritizing those that are advantageous to the distributor in view of their sales strategy; and a step of displaying a presentation of a menu of commodity candidates and specifications as the result of searching and prioritizing.

Another embodiment of the present invention provides a method for displaying a limited list of goods to a consumer by a distributor over network. The method includes receiving a customer requirement for goods; retrieving from a database a prioritized list of goods meeting the customer requirement; forming a reduced list from the prioritized list of goods based on a predetermined restriction; and displaying only high priority items from the reduced list to the customer.

Yet another embodiment of the present invention provides a system for a consumer to view different levels in a distributor's hierarchical list of goods, where the system includes: one or more component dependency trees for goods maintained by a distributor, where a component of a tree has one or more sub-components; a rating scheme for assigning promotion points to the one or more sub-components, where a component rating is a sum of the component's sub-components promotion points; an user input for selecting a level of the component dependency trees, that the user wants displayed; and a distributor ordering mechanism based on the promotion points, such that only a portion of goods available at the level is displayed to the user.

These and other embodiments of the present invention are described in more detail in conjunction with the text below and attached figures.

### BRIEF DESCRIPTION OF THE DRAWINGS

FIG. 1 is the schematic drawing of a system configuration of one embodiment of the present invention;

FIG. 2 is a table of the customer order requirements of an embodiment of the present invention;

FIG. 3 is a table of stock file, level 1 (for example full-prepared) of an embodiment of the present invention;

FIG. 4 is a table of stock file, level 2 (for example foodstuff set) of an embodiment of the present invention;

FIG. 5 is a table of stock file, level 3 (for example discrete foodstuff of an embodiment of the present invention;

FIG. 6 is a table of prioritized items of promotion file, level 1 of an embodiment of the present invention;

FIG. 7 is a table of prioritized items of promotion file, level 2 of an embodiment of the present invention;

FIG. 8 is a table of prioritized items of promotion file, level 3 of an embodiment of the present invention;

FIG. 9 is an example of a table of component table master, level 1;

FIG. 10 is a an example of a table of component table master, level 2;

FIG. 11 is a an example of a table of commodity attribute master, level 1

FIG. 12 is a an example of a table of range-restrictive condition file of an embodiment of the present invention;

FIG. 13 is a an example of a table of order record file;

FIG. 14 is a an example of a table of order candidates to be offered in a menu due to file search of an embodiment of the present invention;

FIG. 15 is the prioritized items of promotion table, level 3 . updated of an embodiment of the present invention;

FIG. 16 is the table of order candidates to be offered in a menu due to file search, updated of an embodiment of the present invention;

FIG. 17 is the main flowchart of an embodiment of the present invention;

FIG. 18 is the flowchart of furnishing the conditions for foodstuff selection (process 1) of an embodiment of the present invention;

FIG. 19 is the flowchart of searching for the prioritized foodstuff items of promotion (process 2) of an embodiment of the present invention;

FIG. 20 is the flowchart of searching for order candidates to be offered in a menu (process 3) of an embodiment of the present invention;

FIG. 21 is the flowchart of restricting the range of order candidates in a menu (process 4) of an embodiment of the present invention; and

FIG. 22 is the flowchart of displaying the menu created by search (process 5) of an embodiment of the present invention.

### DESCRIPTION OF THE SPECIFIC EMBODIMENTS

An embodiment of the present invention will be explained below, using a cyber foodstuff distribution system as an example where a consumer may order and purchase foodstuffs for cooking or full-prepared food as the consumer wants. An example would be a consumer purchasing over the Web either a pizza or a kit to make the pizza or the raw ingredients. The cyber foodstuff distribution system is for purposes of illustration only, for example the same method and system may be applied to the purchase of a personal computer. For example, a consumer may want to purchase a system package, including the PC, CRT, keyboard, and mouse or the consumer may want to purchase all the component pieces and assembly it him/her self.

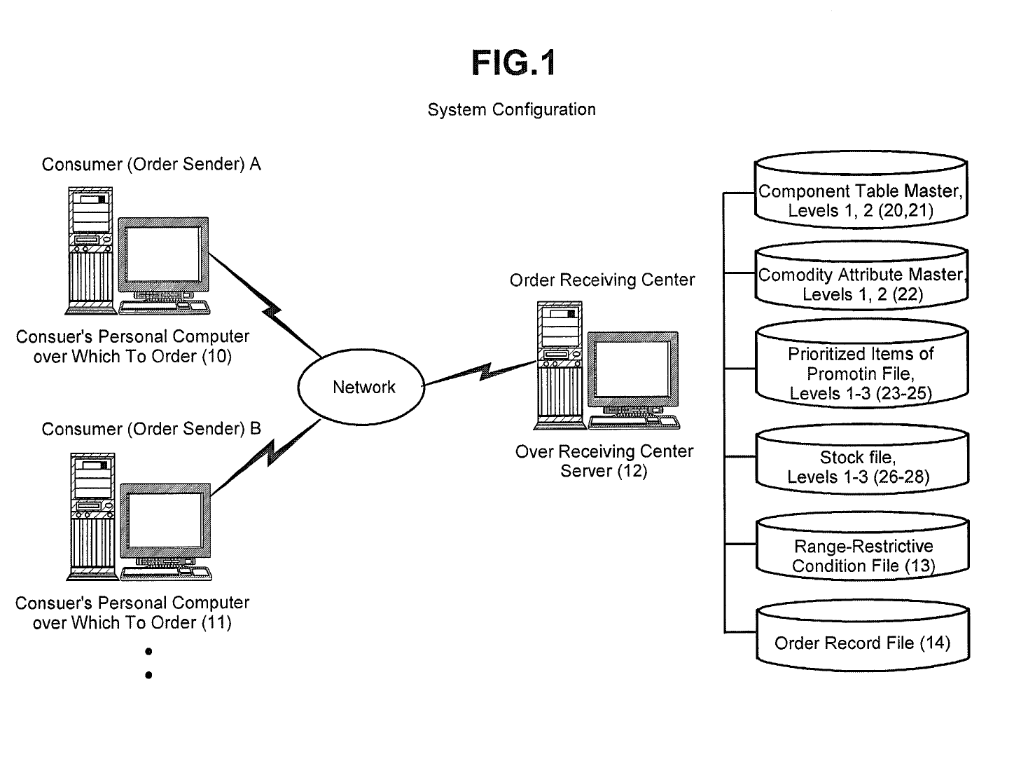

FIG. 1 shows a system configuration for one embodiment of the present invention.

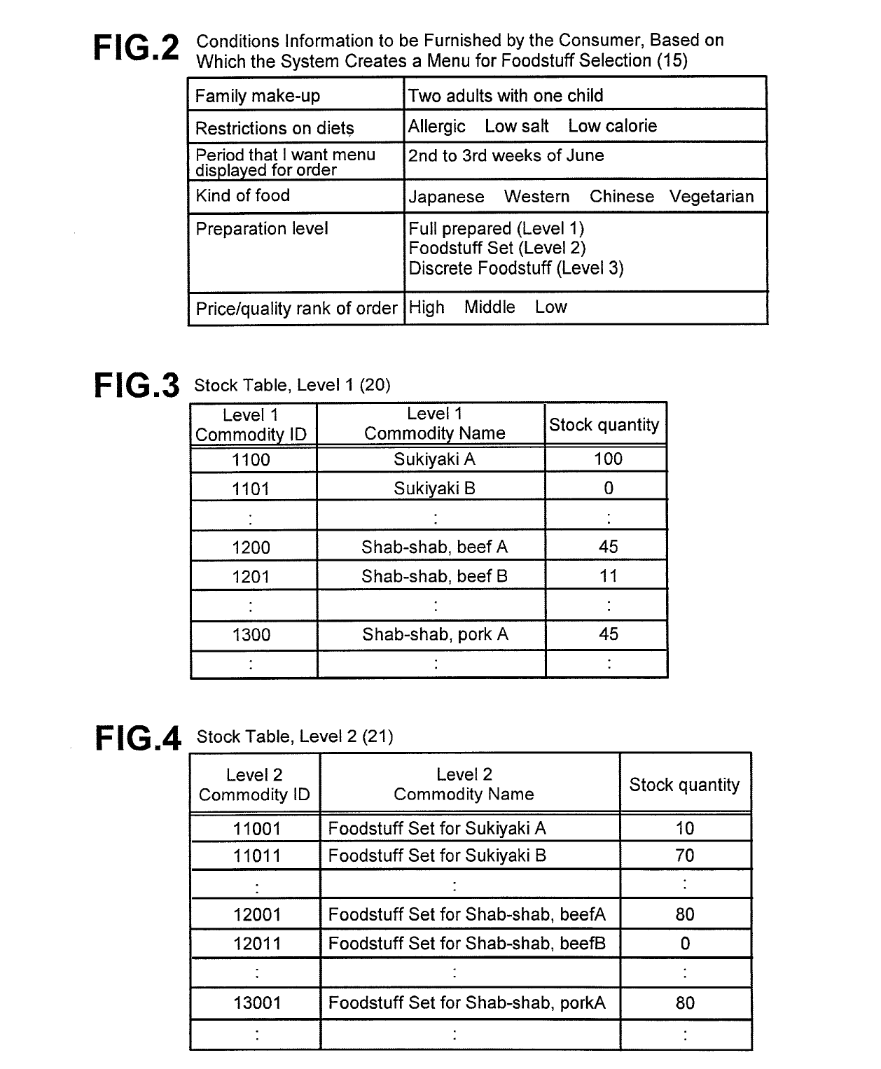

FIGS. 2 to 16 show tables of files stored in the storage of a server of one embodiment of the present invention

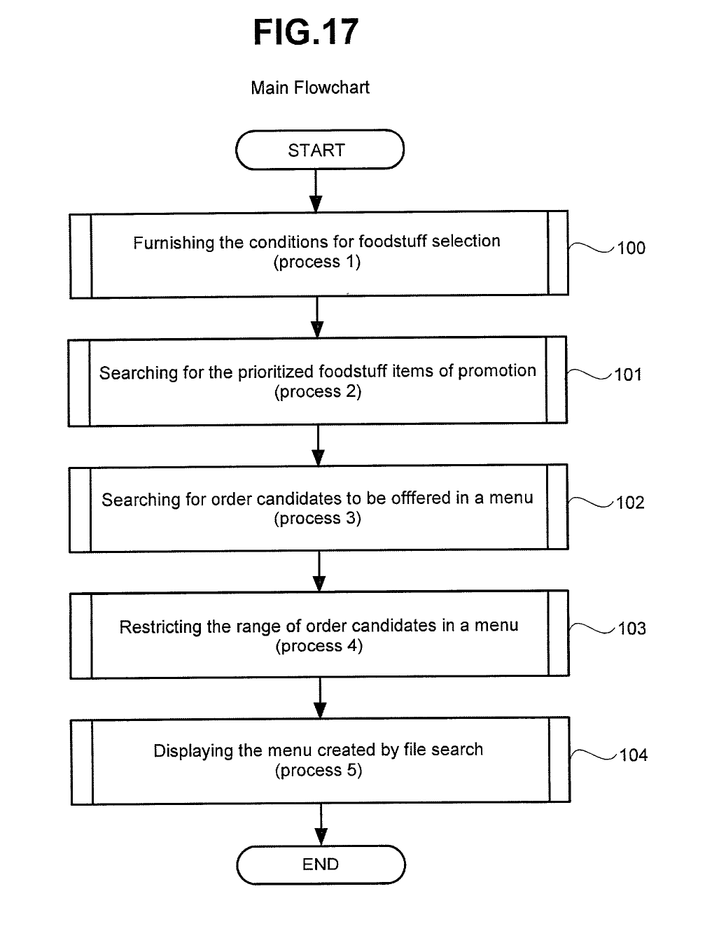

FIGS. 17 to 22 show flowcharts illustrating how one embodiment of the present invention is implemented.

An electronic commerce system to which one embodiment of the present invention is applied, shown in FIG. 1, comprises a plurality of consumer's personal computers (10 and 11) over which orders are placed in their sites and an order receiving center server (12) that is installed in an order receiving center to receive orders from them; the consumer's personal computers and the receiving center/server are interconnected via a network. The consumer's personal computers over which to order (10) and (11) are installed in the consumer sites and used by the consumer to order and purchase commodities over the network. The order receiving center server (12) is installed in the order receiving center and used for receiving orders from the consumer and executing related processing. Although this system embodiment example comprises the personal computers and the server, any other system embodiment may be applicable if it meets the requirements of the invention. Files 20 to 30 are stored in the storage connected to the order receiving center server (12).

FIG. 2 is a table (15) of conditions information to be furnished by the consumer, based on which the system creates a menu for foodstuff selections. This is an example of the information to be specified by the consumer, which is registered with the system as the conditions for seeking items to order, when initiating the transaction of buying a commodity by electronic commerce.

FIG. 3 is a table (20) of a stock file, level 1 (full-prepared), containing the quantity of stock per level 1 (full-prepared) menu item.

FIG. 4 is a table (21) of a stock file, level 2 (foodstuff set, i.e., food kit for making the level 1 item), containing the quantity of stock per level 2 (foodstuff set) menu item.

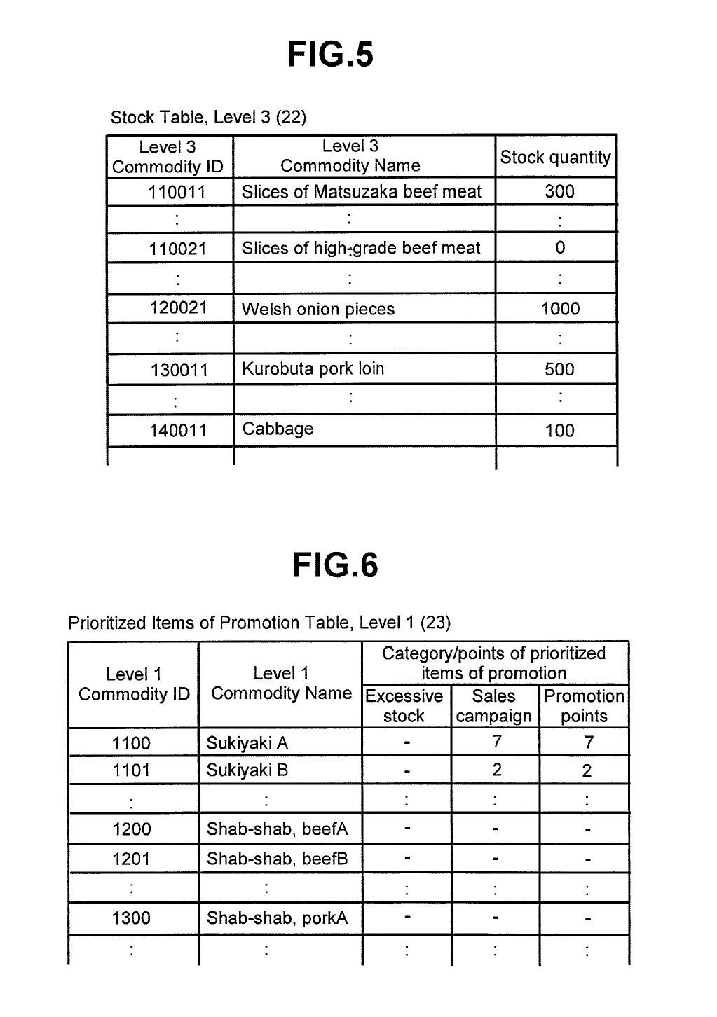

FIG. 5 is a table (22) of a stock file, level 3 (discrete foodstuff, i.e., individual ingredients for making the level 2 item), containing the quantity of stock per level 3 (discrete foodstuff) menu item.

FIG. 6 is a table (23) of a prioritized items of promotion file, level 1 (full-prepared). This table contains prioritized items of promotion of level 1 (full-prepared) menu items categorized as “excessive stock” and “sales campaign” with “promotion points.” For example, if excessive stock is zero, then there are no items at all in the inventory. The sales campaign may be, for example, a natural number, representing the distributors emphasis to sell the item.

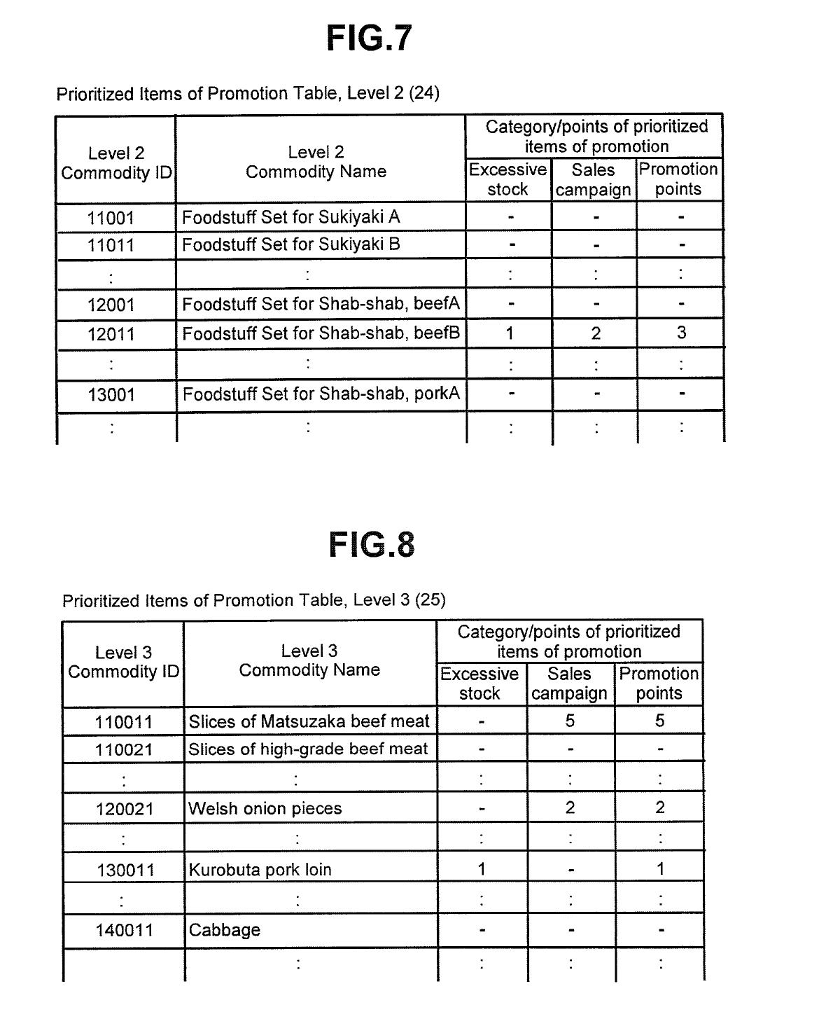

FIG. 7 is a table (24) of a prioritized items of promotion file, level 2 (foodstuff set). This table contains prioritized items of promotion of level 2 (foodstuff set) menu items categorized as “excessive stock” and “sales campaign” with “promotion points.”

FIG. 8 is a table (25) of a prioritized items of promotion file, level 3 (discrete foodstuff). This table contains prioritized items of promotion of level 3 (discrete foodstuff) menu items categorized as “excessive stock” and “sales campaign” with “promotion points.”

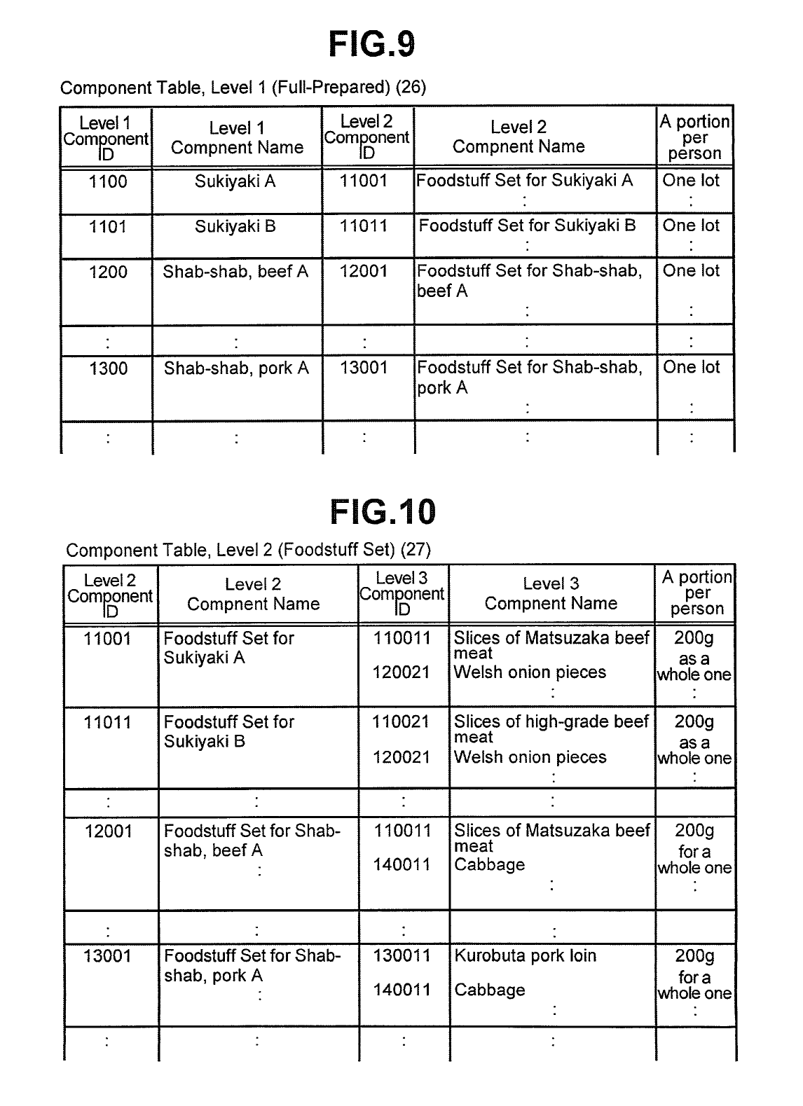

FIG. 9 is a table (26) of a component table master, level 1 (full-prepared), containing level 1 (full-prepared) menu items and their constituent foodstuff sets of level 2 (foodstuff set).

FIG. 10 is a table (27) of a component table master, level 2 (foodstuff set), containing level 2 (foodstuff set) menu items and their constituent foodstuffs of level 3 (discrete foodstuff).

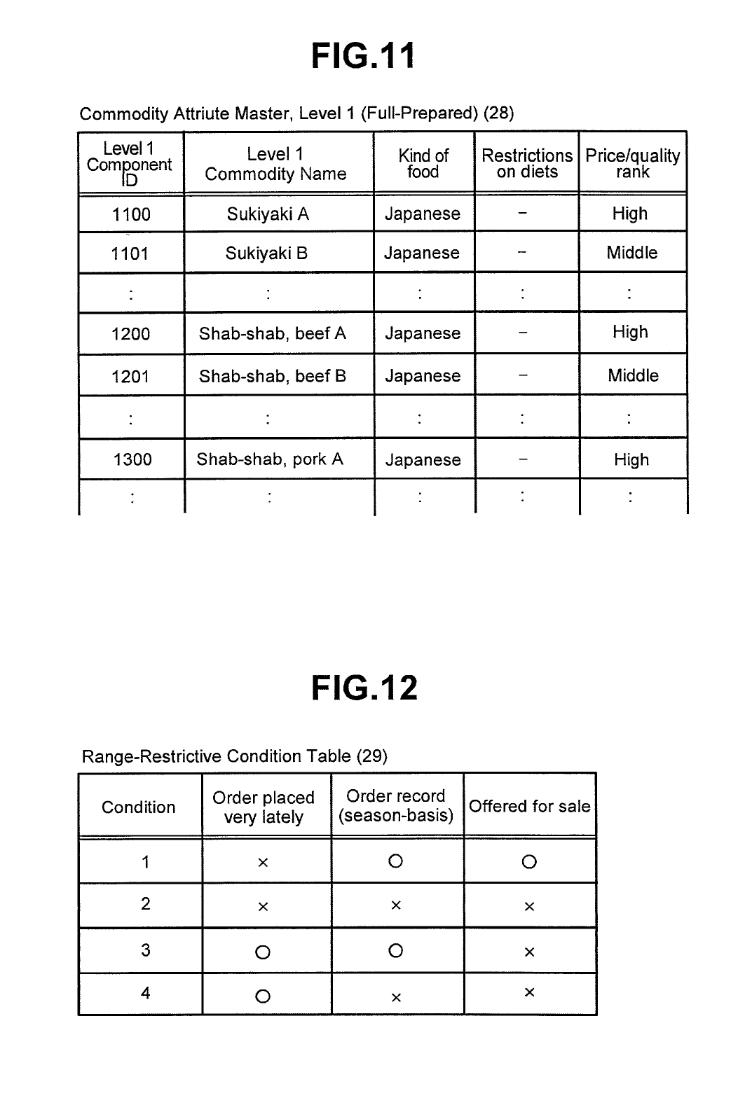

FIG. 11 is a table (28) of a commodity attribute master, level 1 (full-prepared), containing level 1 (full-prepared) menu items with the consumer-specified attributes of “Kind of food,” “Restrictions on diets,” and “Price/quality rank.”

FIG. 12 is a range-restrictive condition table (29) containing the conditions for restricting the range of order candidates to be offered in a menu to the consumer.

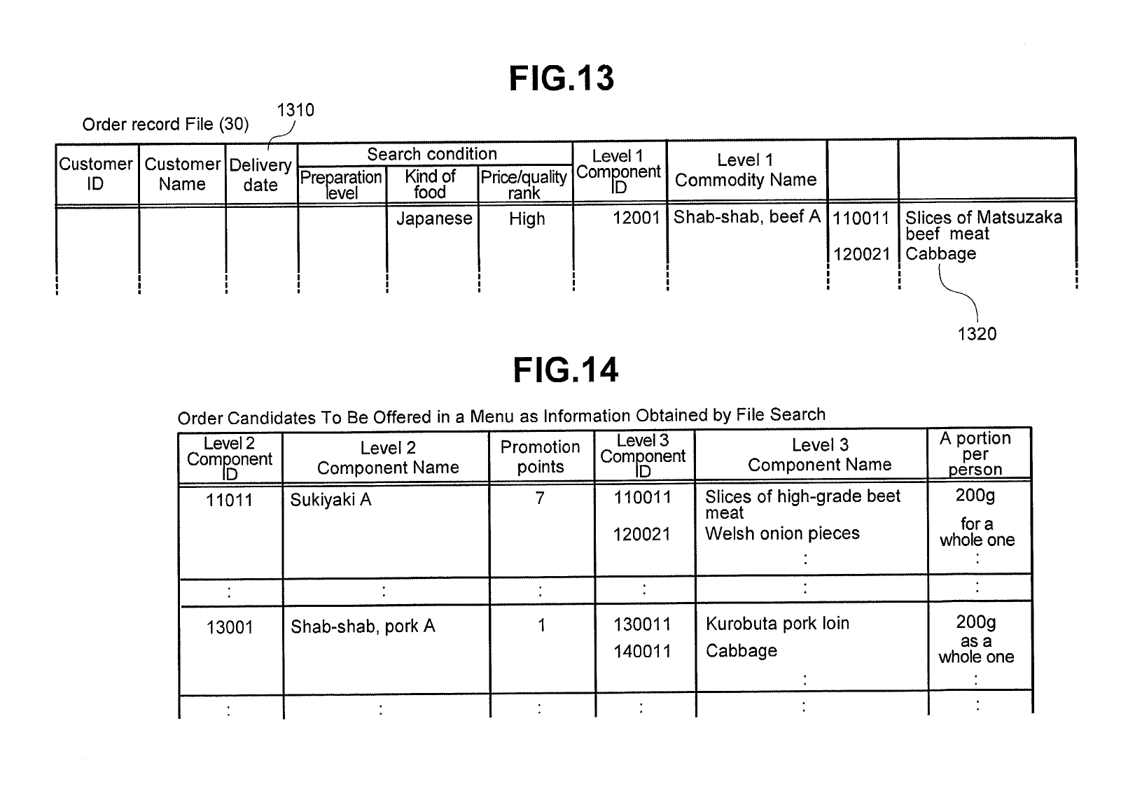

FIG. 13 is a table (30) of an order record file.

FIG. 14 is a table of order candidates to be offered in a menu due to file search, giving examples of order candidates to be offered in a menu to the consumer.

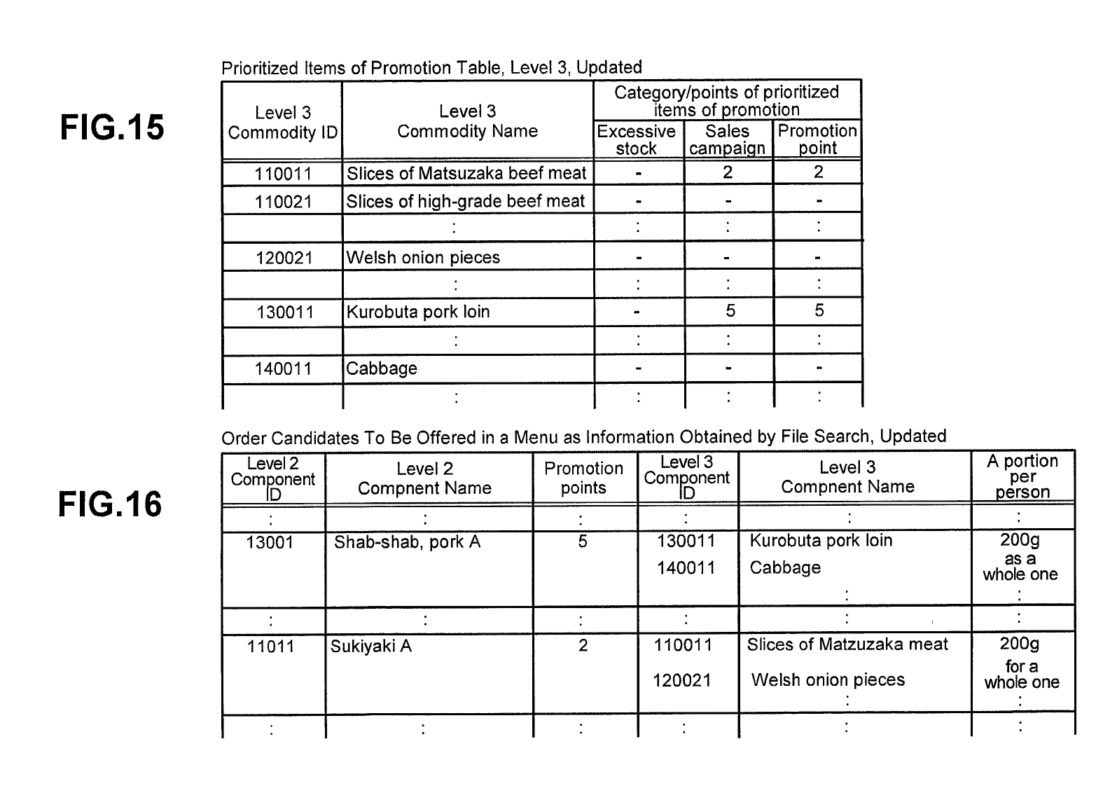

FIG. 15 is the prioritized items of promotion table, level 3 (discrete foodstuff), with the promotion points updated.

FIG. 16 is an example of the table of order candidates to be offered in a menu due to file search, updated by the updated promotion points.

FIGS. 17 to 22 are flowcharts illustrating how an embodiment of the present invention is implemented. Based on these flowcharts, the flow of processing of the embodiment will be explained.

FIG. 17 is the main flowchart of an embodiment of the present invention.

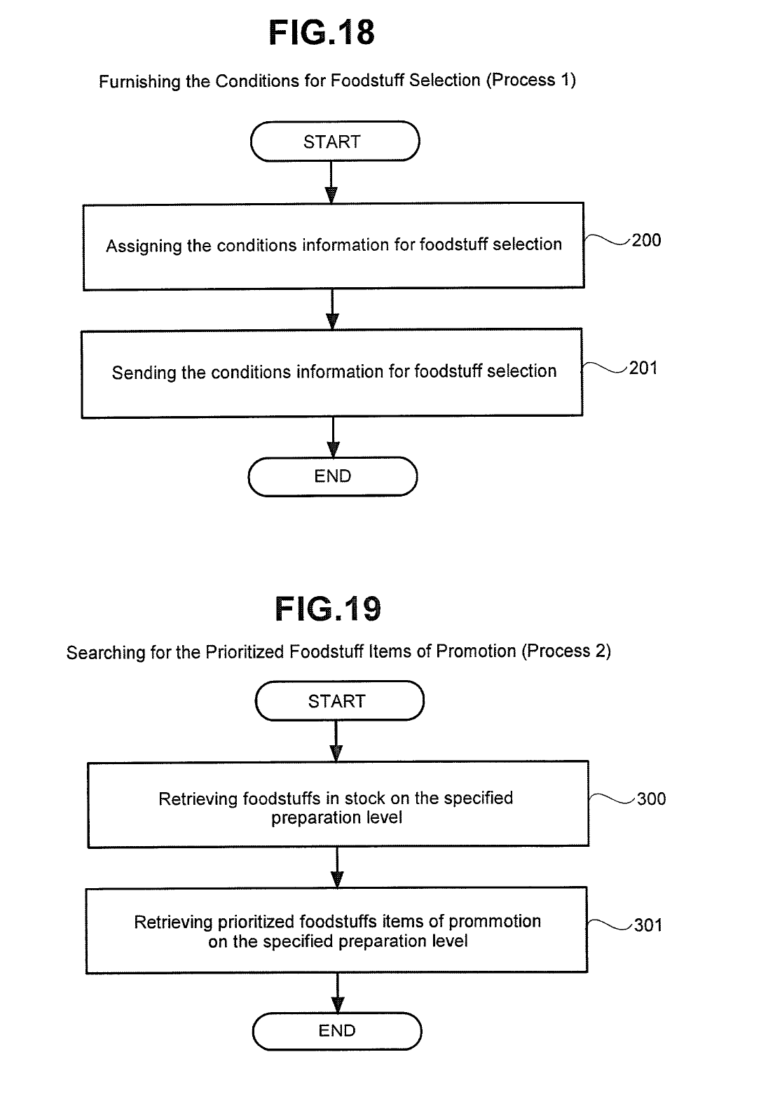

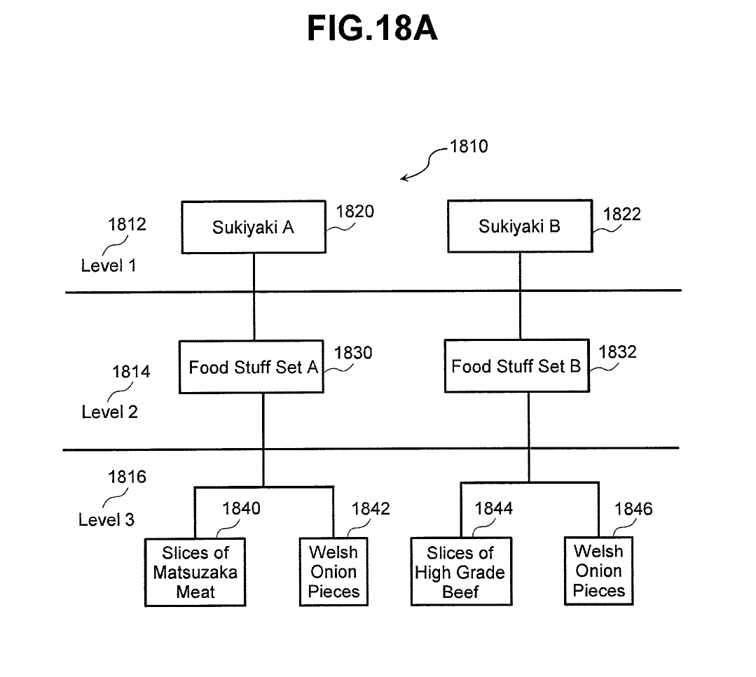

Furnishing the conditions for foodstuff selection (process 1) [100] is a process in which the consumer specifies the conditions, based on which the system creates a menu for foodstuff selection, and sends the above conditions to the order receiving center. (For detail, see FIG. 18; Furnishing the Conditions for Foodstuff Selection (Process 1).)

Searching for the prioritized foodstuff items of promotion (process 2) [101] is a process in which the prioritized foodstuff items set by the distributor as those that the distributor intends to sell particularly are retrieved from the file database. (For detail, see FIG. 19; Searching for the Prioritized Foodstuff Items of Promotion (Process 2).)

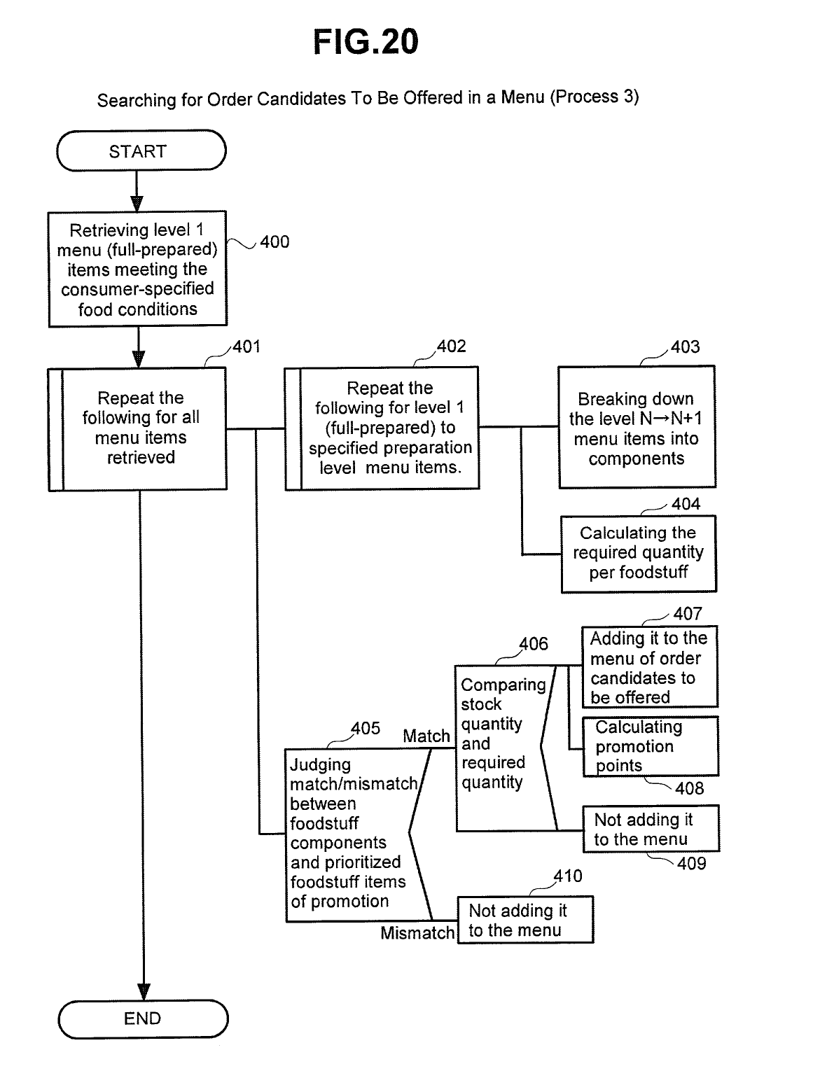

Searching for order candidates to be offered in a menu (process 3) [102] is a process in which foodstuff items to be offered in a menu, meeting the conditions specified by the customer for foodstuff selection and matching the prioritized items of promotion set by the distributor, are retrieved from the file database. (For detail, see FIG. 20; Searching for Order Candidates To Be Offered in a Menu (Process 3).)

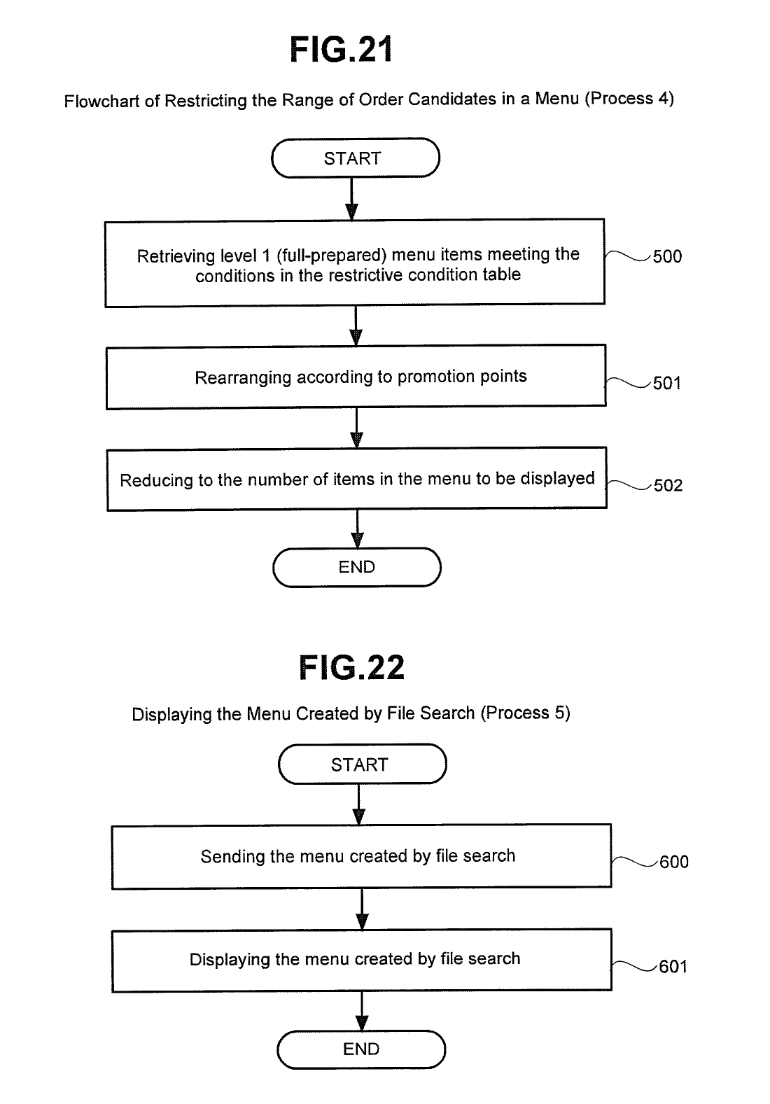

Restricting the range of order candidates in a menu (process 4) [103] is a process in which the foodstuff items to be offered in a menu retrieved by the process of searching for order candidates to be offered in a menu (process 3) [102] are reduced to the number of items to be offered in a menu that is actually presented to the consumer. (For detail, see FIG. 21; Restricting the Range of Order Candidates in a Menu (Process 4).)

Displaying the menu created by search (process 5) [104] is a process in which the menu containing the items fixed by the process of restricting the range of order candidates in a menu (process 4) [103] is sent to the consumer's personal computer and presented to the consumer. (For detail, see FIG. 22; Displaying the Menu Created by File Search (Process 5).)

FIG. 18; Furnishing the Conditions for Foodstuff Selection (Process 1) is a process in which the consumer specifies the conditions, base on which the system creates a menu for foodstuff selection, and sends the above conditions to the order receiving center.

Assigning the conditions information for foodstuff selection [200]: the consumer assigns conditions information (15), based on which the system creates a menu for foodstuff selections, to the entry form displayed on the screen of the consumer's personal computer (10 or 11). The conditions include: the preparation level of foodstuff (full-prepared, foodstuff set, or discrete foodstuffs), that is, the consumer wants the ordered item prepared on this level when supplied; price/quality rank (high, middle, low) of the foodstuff/food to order; kind of food that the consumer likes (Western, Japanese, Chinese, etc.); restrictions on diets on account of health matters (low calorie, low salt, allergy), and others.

Sending the conditions information for foodstuff selection [201]: the above conditions information (15) assigned by the consumer is sent from the consumer's machine to the order receiving center server (12).

FIG. 18A shows another view of the Preparation level given in FIG. 2 of an embodiment of the present invention. The consumer selects the level of detail (level 1 1812, level 2 1814, or level 3 1816) he/she wishes to see displayed. For example if the consumer selects level 1 1812 for Sukiyaki then he/she wants only to see the different fully prepared packages, e.g. sukiyaki A 1820 and sukiyaki B 1822 offered by the distributor. If the consumer selects level 2 then he/she wants a pre-assembled kit of ingredients to make Sukiyaki. For example Food Stuff Set A 1830 and Food Stuff set B 1832. If the consumer selects level 3 1816 then he/she is a do-it-yourself person and probably wants to see all level 3 1816 items, e.g., slices of Matsuzaka meat 1840 and Welsh Onion Pieces 1842 for Food stuff Set A 1830 and slices of High Grade Beef 1844 and Welsh Onion Pieces 1846 for Food stuff Set B 1832. One embodiment of this invention limits via promotion restrictions on what the distributor has and what the consumer sees. For example the distributor may prioritize level 1 1812 such that the consumer only is shown Sukiyaki A 1820. Sukiyaki B 1822 may be shown when all supplies of Sukiyaki A 1820 are gone or if the distributor changes his/her sales strategy. In level 3, for example, the distributor may have an excessive stock of Matsuzaka meat 1840 and thus may assign more promotion points (higher priority) to the Slices of Matsuzaka meat 1840/Welsh Onion Pieces 1842 combination over the Slices of High Grade Beef 1844/Welsh Onion Pieces 1846 combination. Thus if the customer asks in FIG. 2 (15) for a “Discrete Food Stuff (Level 3)” view, the distributor will only display the Slices of Matsuzaka meat 1840/Welsh Onion Pieces 1842 combination. In sum, for this embodiment, the intersection between the customer's needs and distributor's sales policy is displayed to the customer on, for example, his/her Web browser.

FIG. 19; Searching for the Prioritized Foodstuff Items of Promotion (Process 2) is a process in which the prioritized foodstuff items set by the distributor as those that the distributor intends to sell particularly are retrieved from the file database.

Retrieving foodstuffs in stock on the specified preparation level [300]: among the stock tables (20 to 22) shown in FIGS. 3 to 5, the table appropriate for the preparation level specified by the consumer is referenced and the foodstuffs in stock are retrieved.

Retrieving prioritized foodstuff items of promotion on the specified preparation level [301]: among the prioritized items of promotion tables (23 to 25) shown in FIGS. 6 to 8, the table appropriate for the preparation level specified by the consumer is referenced and the foodstuffs with promotion points are further retrieved. The promotion points are assigned to the foodstuffs that the distributor wants to sell particularly in view of their sales strategy (such as early selling of excessive stock and key commodities of channel strategy), according to the significance of promoting the foodstuff. In this example of an embodiment of the invention, the promotion points is the sum of “excessive stock” points and “sales campaign” points for each prioritized item of promotion. The “excessive stock” points are assigned by the distributor, according to how much excessive stock of foodstuff exists. The “sales campaign” points are assigned by the distributor, according to the priority of foodstuff to sell by campaign.

As a simple example using FIG. 18A and FIG. 6, if the customer asks for full prepared Sukiyaki at level one, Sukiyaki A has 7 promotion points, while Sukiyaki B has 2 promotion points. Hence the distributor should only offer, i.e., display to, the consumer Sukiyaki A. This calculation, as we will see, is done as follows. From FIGS. 9 and 10, we can follow up the chain from the level 3 (ingredients) to the level 2 (foodstuff set) to level 1 (full-prepared). This can also be seen in FIG. 18A. There are promotion points in this case only at level 3 (FIG. 8). Thus adding them up Sukiyaki A has 5 (Matsuzaka beef) plus 2 (onions)=7 and Sukiyaki B has 0 (High-grade beef) plus 2 (onions)=2.

Therefore the algorithm for adding promotion points is as follows: 1) the consumer selects which level he wants to view; this gives the top of the sub-trees he/she wants to see; 2) promotion points on all lower levels, starting from the leaf nodes, are iteratively added up; 3) the result is that each item at the level the consumer wants to see has an accumulated sum of all lower levels promotion points associated with that item, i.e., sub-tree for that item. and 4) the distributor decides based on the totaled promotion points for each item, which items he/she wishes to show the consumer.

FIG. 20; Searching for Order Candidates To Be Offered in a Menu (Process 3) is a process in which foodstuff items to be offered in a menu, meeting the conditions specified by the customer for foodstuff selection and matching the prioritized items of promotion set by the distributor, are retrieved from the file database.

Retrieving level 1 menu (full-prepared) items meeting the consumer-specified food conditions [400]: based on the commodity attribute table (28), level 1 (full-prepared), shown in FIG. 11, menu items appropriate for “Kind of food,” “Restrictions on diets,” and “Price/quality rank” specified by the consumer as conditions information for foodstuff selections shown in FIG. 2, are retrieved from the file database.

Repeat the following for all menu items retrieved [401]: the following steps [402] to [410] are repeated for all menu items retrieved in the step [400].

Repeat the following for level 1 (full-prepared) to specified preparation level menu items [402]: the following steps [403] and [404] are repeated for the appropriate menu items of level 1 (full-prepared) to the “preparation level” specified by the consumer as the conditions information for foodstuff selections shown in FIG. 2.

Breaking down the level N−>N +1 menu items into components [403]: based on the component tables (26, 27) show in FIGS. 9 and 10, the appropriate menu items are broken down into components and all foodstuff components are obtained on the specified preparation level.

Calculating the required quantity per foodstuff [404]: based on the value of “a portion per person” per foodstuff in the component tables (26. 27) shown in FIGS. 9 and 10, the required quantity of each of the foodstuff components obtained in the step [403] is calculated.

Judging match/mismatch between foodstuff components and prioritized foodstuff items of promotion [405]: each of the foodstuff components obtained in the step [403] is judged for the match/mismatch with the prioritized foodstuff items of promotion retrieved in the step [101]. If the judgment is the match, the following steps [406] to [409] are executed. If the judgment is the mismatch, the processing goes to a step [401].

Comparing stock quantity and required quantity [406]: with the reference to the stock tables (20 to 22) shown in FIGS. 3 to 5, the required quantity of foodstuff calculated in the step [404] is compared with its stock quantity. If the stock quantity is equal or greater, the steps [407] and [408] are executed. If the required quantity is greater, the step [409] is executed.

Adding it to the menu of order candidates to be offered [407]: the foodstuff menu item that is the object of processing is added to the menu of order candidates to be offered/displayed to the consumer.

Calculating promotion points [408]: promotion points of a level 1 (full-prepared) menu item are calculated by summing up the promotion points of its foodstuff components obtained in the step [403]. Also as explained above in relationship to FIG. 18A, if the consumer wants to see a level below level 1 the promotion points are calculated for the desired level as explained previously.

Not adding it to the menu [409]: the foodstuff menu item that is the object of processing is not added to the menu of order candidates to be offered to the consumer.

FIG. 21; Restricting the Range of Order Candidates in a Menu (Process 4) is a process in which the foodstuff items to be offered in a menu retrieved by the process of searching for order candidates to be offered in a menu (process 3) illustrated in FIG. 20 are reduced to the number of items to be offered in a menu that is actually presented to the consumer.

Retrieving level 1 (full-prepared) menu items meeting the conditions in the restrictive condition table [500]: from among the menu items as order candidates retrieved by the process of searching for order candidates to be offered in a menu (process 3), those that meet the conditions in the restrictive condition table (29) shown in FIG. 12 are retrieved. The restrictive condition table (29) shown in FIG. 12 defines some conditions 1212 for making the menu more useful for the consumer. In this example of embodying the invention, whether or not some order has been placed recently 1214 and whether or not a season-basis order record exists 1214 are determined by using the order record file (30) shown in FIG. 13. In FIG. 13 looking at the delivery date 1310 how recent the order may be determined. Examining the ingredients 1320 and referring to a list of seasonal items, the order can be determined to be season-based. From column 1216 which conditions 1210 must be fulfilled before an order is offered to the consumer is given. For example in FIG. 12, only goods in season, that a customer has not ordered recently (condition 1) will be offered.

Rearranging according to promotion points [501]: the menu items are rearranged by the promotion points calculated per menu item in the step [408] so that highest point item will be on the top.

Reducing to the number of items in the menu to be displayed [502]: the number of items in the menu to be offered is reduced to the number in the menu that is actually presented to the consumer.

The reduction to the number of items in the menu to be offered is implemented by screening based on the promotion points calculated in the step [408] or such screening in combination with other method such as random extraction processing. In this example of an embodiment of the invention, the items of higher promotion points are prioritized in the processing of reduction to the number of items in the menu to be offered.

With regard to how many menus are to be created and offered, as many menus as the number of days specified by the consumer during which the consumer wants a menu displayed for order may be automatically created and offered for order; alternatively, more menus than the above number of days may be created and offered, when the consumer may choose out of them. The number of menus is set, according to the customer need.

FIG. 22; Displaying the Menu Created by File Search (Process 5) is a process in which the menu containing the items fixed by the process of restricting the range of order candidates in a menu (process 4) is sent to the consumer's personal computer and presented to the consumer.

Sending the menu created by file search [600]: the menu information fixed in the step [502] is sent from the order receiving center server (12) to the consumer's personal computer (10 and 11).

Displaying the menu created by file search [601]: the received menu information by the step [600] is displayed on the consumer's personal computer (10 and 11) as the order candidates offered in the menu as the information obtained by file search shown in FIG. 14.

How the change to the distributor's sales strategy changes the menu to be offered will be explained below, using examples. Note the promotion points in FIG. 8, Prioritized Items of Promotion Table, Level 3 (25). The promotion points of “Slices of Matsuzaka beef meat” and “Welsh onion pieces” which are component foodstuffs of “Sukiyaki A” are 5 and 2 respectively and other foodstuff promotion points are 0, thus the promotion points of “Sukiyaki A” are 5+2=7. The promotion points of “Kurobuta pork loin” and “Cabbage” which are component foodstuffs of “Shab-shab, pork A” are 1 and 0 respectively and other foodstuff promotion points are 0, thus the promotion points of “Shab-shab, pork A” are 1. Consequently, the position of “Sukiyaki A” is higher than “Shab-shab, pork A” in the menu, which corresponds to the priority of search, as shown in FIG. 14, Order Candidates To Be Offered in a Menu as Information Obtained by File Search.

Then, the distributor's sales strategy is assumed to change as shown in FIG. 15, Prioritized Items of Promotion Table, Level 3, Updated. Here, the promotion points of “Slices of Matsuzaka beef meat” and “Welsh onion pieces” which are component foodstuffs of “Sukiyaki A” are 2 and 0 respectively and other foodstuff promotion points are 0, thus the promotion points of “Sukiyaki A” are 2. On the other hand, the promotion points of “Kurobuta pork loin” and “Cabbage” which are component foodstuffs of “Shab-shab, pork A” are 5 and 0 respectively and other foodstuff promotion points are 0, thus the promotion points of “Shab-shab, pork A” are 5. Consequently, the position of “Shab-shab, pork A” becomes higher than “Sukiyaki A” in the menu, corresponding to the priority of search, as shown in FIG. 16, Order Candidates To Be Offered in a Menu as Information Obtained by File Search, Updated.

In this way, the priority of search can be changed by reflecting the change to the distributor's sale strategy.

As explained above, the electronic commerce goods data search method according to one embodiment of the present invention enables: seeking and presenting commodities of definite specifications as order candidates, based on the consumer-specified general requirements; making the distributor's intention reflected in the seeking process; and thus prioritizing specifications and commodities matching the distributor's intention/strategy during the seeking and offering selected goods to the customer.

A further embodiment provides a computer program product stored in a computer readable medium for displaying a limited list of goods to a consumer by a distributor over a network. The computer program product includes: code for receiving a customer requirement for goods; code for retrieving from a database a prioritized list of goods meeting said customer requirement; code for forming a reduced list from said prioritized list of goods based on a predetermined restriction; and code for displaying high priority items from said reduced list to said customer.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. Therefore, it is to be understood that within the scope of the appended claims, the invention may be practiced otherwise than as specifically described.

What is claimed is:

1. An electronic commerce goods ordering method comprising:
specifying broad conditions for ordering a desired commodity by a consumer;
searching a database for commodities having definite specifications meeting the broad conditions specified by the consumer;
prioritizing the commodities found by said searching based on a distributor's sales strategy; and
displaying to the consumer a subset of the commodities found above a predetermined distributor set priority level.

2. The electronic commerce goods ordering method according to claim 1, wherein: the consumer, when ordering, is prompted to specify a category of a plurality of categories, said plurality comprising a “complete product,” a “set of components,” or “discrete components.”

3. The electronic commerce goods ordering method according to claim 1, wherein, the consumer, when ordering, is prompted to specify a type of food.

4. The electronic commerce goods ordering method according to claim 1, wherein, the consumer, when ordering, is prompted to specify a restriction on diet.

5. The electronic commerce goods ordering method according to claim 1, wherein, the consumer, when ordering, is prompted to specify a price constraint, said price constraint including low, medium, or high.

6. A method for displaying a limited list of goods to a consumer by a distributor over network, said method comprising:
receiving a customer requirement for goods;
retrieving from a database a prioritized list of goods meeting said customer requirement;
forming a reduced list from said prioritized list of goods based on a predetermined restriction; and
displaying high priority items from said reduced list to said customer.

7. The method of claim 6 wherein said predetermined restriction is selected from a group consisting of recency of order placement or seasonal basis of a good of said prioritized list of goods.

8. The method of claim 6 wherein said prioritized list of goods comprises goods having promotion points, each good of said prioritized list of goods having zero or more promotion points.

9. The method of claim 8 wherein said promotion points comprise points for excessive stock and sales campaign points.

10. A system for a consumer to view different levels in a distributor's hierarchical list of goods, said system comprising:
a plurality of component dependency trees for goods maintained by a distributor, wherein a component of a tree of said plurality of component dependency trees has one or more sub-components;
a rating scheme for assigning promotion points to said one or more sub-components, wherein a component rating is a sum of said component's sub-components promotion points;
an user input for selecting a level of said component dependency trees, that said user wants displayed; and
a distributor ordering mechanism based on said promotion points, such that only a portion of goods available at said level is displayed to said user.

11. The system of claim 10 wherein said distributor ordering mechanism selects goods for display to said consumer with promotion points above a predetermined level.

12. The system of claim 10 wherein said distributor ordering mechanism displays goods available at said level according to a predetermine order until a predetermined number to be displayed is reached.

13. A plurality of tables stored in a computer readable medium for storing promotion points related to an item offered by a distributor to a customer via a communications network, said plurality of tables comprising:
a first table having a plurality of first level items , each first level item of said plurality of first level items having a corresponding summation promotion value; and
a second table having a second level of a plurality of second level items, wherein a first level item of said plurality of first level items has at least one second level item and wherein said first level item's corresponding summation promotion value includes said at least one second level item corresponding addition promotion value.

14. The plurality of tables of claim 13 further comprising
a third table having a third level of a plurality of third level items, wherein a second level item of said plurality of second level items has at least one third level item and wherein said second level item's corresponding addition promotion value includes said at least third level item corresponding sub-addition promotion value.

15. The plurality of tables of claim 13 wherein said promotion values at each level are used by said distributor in determining a menu of items displayed to said customer, when said customer places an order related to said items.

16. A database system comprising a plurality of items that may be ordered by a customer computer at a user selected level of a plurality of levels, and for use in returning an order menu to said customer computer, said database system comprising:
a plurality of component tables for showing the relationship between a first item of said plurality of items at a first level of a plurality of levels and one or more second items of said plurality of items at a second level of said plurality of levels, wherein said first item comprises said one or more second items;
a promotion table for each level indicating the promotion points assigned to each item, wherein said first item has promotion points including an addition of promotion points of said one or more second items; and
a menu table for returning to said customer computer a list of offered items at said user selected level, wherein said list of offered items is based on said promotion table for said user selected level.

17. A computer program product stored in a computer readable medium for displaying a limited list of goods to a consumer by a distributor over a network, said computer program product comprising:
code for receiving a customer requirement for goods;
code for retrieving from a database a prioritized list of goods meeting said customer requirement; and
code for forming a reduced list from said prioritized list of goods based on a predetermined restriction.
